(19) United States
(12) Patent Application Publication
(10) Pub. No.: US 2002/0176741 A1
(43) Pub. Date: Nov. 28, 2002

(54) Mirror trim system

(76) Inventor: Carl E. Anderson, Islamorada, FL (US)

Correspondence Address: KATTEN MUCHIN ZAVIS ROSENMAN, 575 MADISON AVENUE, NEW YORK, NY, 10022-2585, US

(21) Appl. No.: 09/863,880

(22) Filed: May 23, 2001

(51) Int. Cl. F16B 1/00; B25G 3/36; E04G 7/00

(52) U.S. Cl. 403/403

(57) ABSTRACT

A mirror is framed with a molding system which includes a plurality of moldings covering the border of the mirror. Each molding has an adhesive backing covered with a removable pull-and-peel cover strip. The moldings can be accurately held in place on the mirror as the cover strips are removed. Comer caps are similarly adhesively set in place over the gaps formed between adjoining moldings.

### BACKGROUND OF THE INVENTION

1. Field of the Invention

The present invention relates in general to molding applied to the borders of a mirror, and in particular to a molding system which eliminates the need for fasteners and other hardware by attaching the moldings to a mirror with doubled-sided adhesive.

2. Description of Prior Developments

Decorative strips of molding are mounted around the borders of mirrors to cover the underlying fasteners and clips which hold the mirrors to walls, doors and other support surfaces. The molding strips are typically held to the mirror with fasteners.

It is a difficult and cumbersome task to hold the molding accurately in place while nailing, screwing or otherwise fastening the molding to the wall surrounding the mirror. It is particularly difficult to apply comer pieces to the molding. That is, it is difficult to accurately align the comer pieces squarely with the adjacent molding pieces while at the same time keeping the comer pieces level.

Accordingly, a need exists for a mirror trim and molding system which is easy to apply and which eliminates the need for fasteners such as screws, nails and bolts. A further need exists for a mirror trim and molding system which includes its own pre-assembled attachment members as an integral part of the trim moldings in order to prevent the loss of loose fasteners.

### SUMMARY OF THE INVENTION

The present invention has been developed to meet the needs noted above and therefore has as an object the provision of a decorative trim and molding system for mirrors which is easy to apply, eliminates the need for separate fasteners and provides integral fastener members which cannot be lost during assembly.

These and other objects are met in accordance with the present invention which is directed to a molding system for providing a decorative trim or frame around a mirror. One example of the molding system includes a set of four molding pieces and four matching comer pieces. Both the molding pieces and comer pieces are held in place with an adhesive member such as double-sided adhesive tape.

The adhesive is provided with a removable covering which can be easily peeled off when the molding and comer pieces are set in place. The adhesive is pre-applied to the molding and comer pieces at a manufacturing facility so that the molding and comer pieces with the attached adhesive members are supplied to an assembler as an integral unit. In this manner, loose fasteners are eliminated. This integral molding and fastener member assembly thereby prevents the loss of loose fasteners at a job site.

A particular advantage of the present invention is the ability to simultaneously level a trim or corner piece while checking the proper alignment of the trim or comer piece with a level. That is, an assembler can hold both the trim molding piece or comer piece and a level with one hand and permanently set the piece in position with the other hand. This advantage is made possible with peel-away coverings which, when removed from the adhesive members, cause the respective pieces to be securely adhesively fixed in position.

The aforementioned objects, features and advantages of the invention will, in part, be pointed out with particularity, and will, in part, become obvious from the following more detailed description of the invention, taken in conjunction with the accompanying drawings, which form an integral part thereof

### BRIEF DESCRIPTION OF THE DRAWINGS

In the drawings:

FIG. 1 is a front elevation view of a mirror fixed to a support surface;

FIG. 2 is a view of FIG. 1 with a molding piece constructed in accordance with the invention and positioned in place prior to attachment;

FIG. 3 is a rear elevation view of the molding piece of FIG. 2;

FIG. 4 is a left side view of FIG. 3 taken along line 4-4 thereof;

FIG. 5 is a view of the mirror of FIG. 1, with four molding pieces adhesively attached in accordance with the invention;

FIG. 6 is a front elevation view of the mirror of FIG. 5, showing the attachment of a comer piece;

FIG. 7 is an enlarged front elevation view of the left top comer piece of FIG. 6;

FIG. 8 is a rear elevation view of FIG. 7;

FIG. 9 is a view in section taken through line 9-9 of FIG. 8;

FIG. 10 is a view in section taken through line 10-10 of FIG. 8; and

FIG. 11 is a right side view of FIG. 7 taken along line 11-11 thereof

In the various views of the drawings, like reference characters designate like or similar parts.

### DETAILED DESCRIPTION OF THE PREFERRED EMBODIMENTS

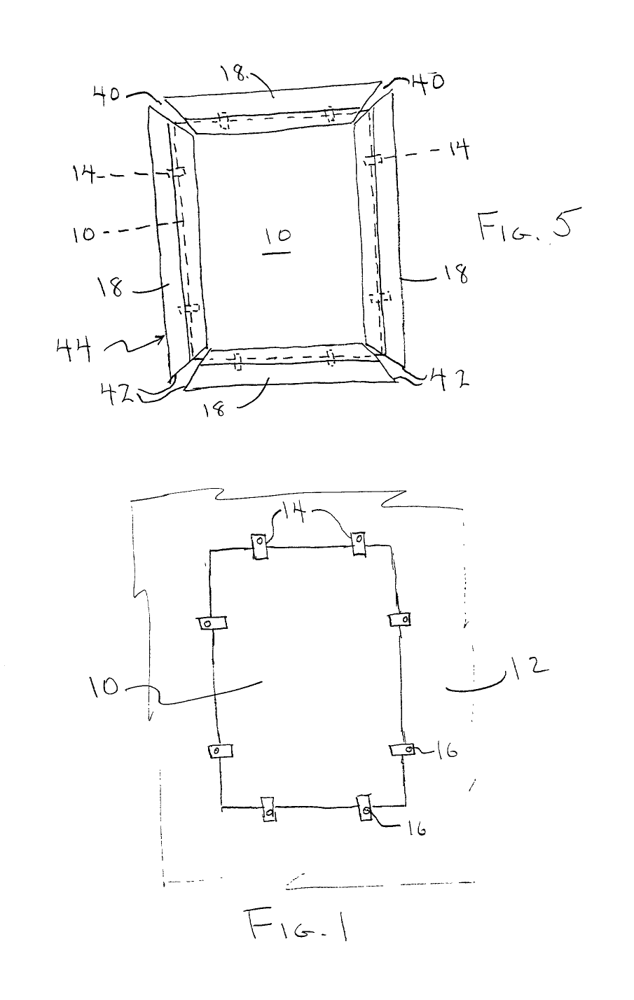

The present invention will now be described in conjunction with the drawings, beginning with FIG. 1, which shows a conventional mirror 10 attached to a wall, or other support surface 12, with conventional clips 14. The clips 14 are secured to the wall 12 with conventional fasteners 16, such as screws or nails.

In order to cover the clips 14 and fasteners 16, as well as to provide a pleasing decorative frame or border around the mirror 10, one or more trim strips or moldings, such as molding 18 shown in FIG. 2, are fastened around the border 20 of the mirror 10. Molding 18 may be formed of any suitable material such as wood, metal, or preferably plastic. The molding 18 may be formed as an extrusion or die casting and may have virtually any decorative surface profile and virtually any cross section to accommodate a particular application.

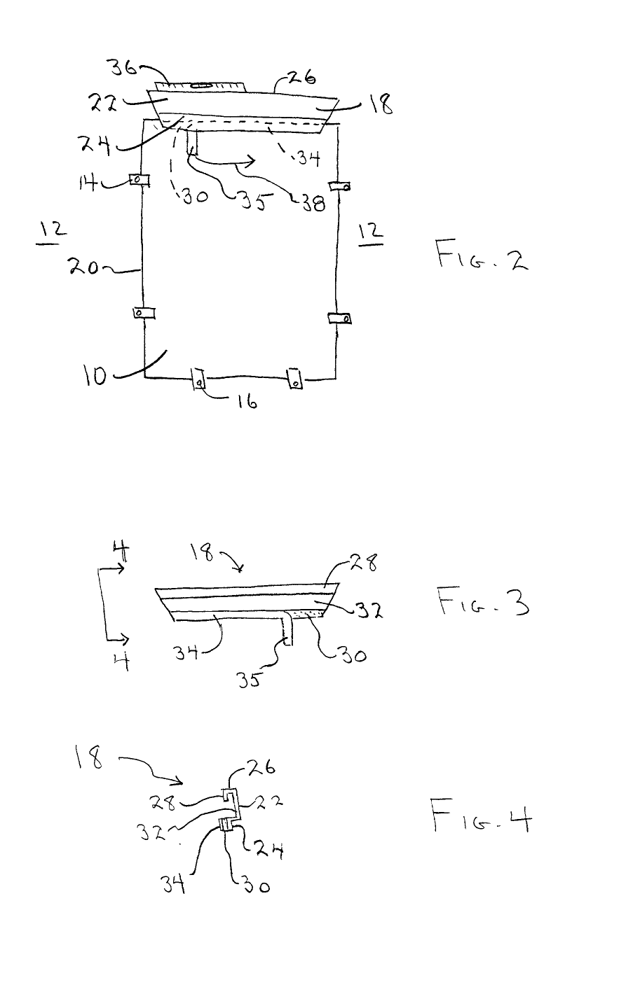

For example, as seen in FIGS. 2, 3 and 4, plastic extruded molding 18 has a planar front face 22 which extends outwardly from a recessed undercut or step 24. A rearwardly extending rim 26 leads to an inwardly extending abutment flange 28 which can abut against support surface 12.

An important feature of the invention is the provision of an adhesive member 30 on the inner surface 32 of molding 18. The adhesive member can take the form of a layer of tacky adhesive such as a rubber cement, or preferably a strip of double-sided adhesive sponge tape, i.e., a foamed plastic tape having adhesive provided on both sides.

The adhesive member 30 is preferably adhesively attached along its interior surface to the rear or inner surface 32 of molding 18 at a production facility where the molding 18 is initially assembled, i.e., preferably prior to sale or use. The outer or exterior surface of the adhesive member 30 is advantageously covered with a thin removable covering 34. Covering 34 may be a thin flexible sheet of non-stick glossy plastic material.

As seen in FIG. 2, an inch or two of the covering 34 is initially peeled off of the adhesive member 30 at a jobsite by an assembler. The molding 18 is then positioned over the border of mirror 10 with a free end portion 35 of covering 34 extending from beneath the molding 18. If desired, a bubble level 36 may be held on the outer edge of the molding 18, i.e. along rim 26, as the molding is adjusted level or square.

The molding 18 and level 36 can be held together against surface 12 with one hand. The assembler can then grasp the free end portion 35 of the covering 34 with the other hand and, while pressing the molding against mirror 10 and surface 12, peel covering 34 completely off the adhesive member 18, as indicated by the directional arrow 38.

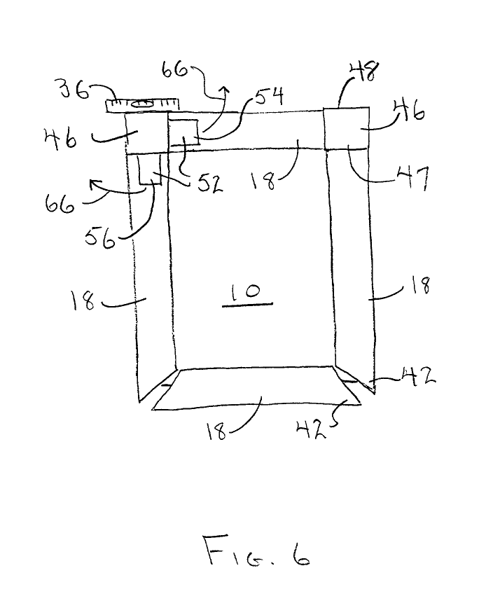

As the covering 34 is peeled away from the molding 18, the molding becomes instantly and permanently attached to the border of the mirror 10 without the use of loose fasteners. This procedure is repeated as many times as necessary to completely enclose and frame mirror 10 with one or more moldings 18. As seen in FIG. 5, four moldings 18 are arranged in a rectangle around the mirror 10. However, a single molding 18 could be formed as a circle, oval rectangle or any other shape and provided with one or more adhesive members 18 and applied to a mirror as described above.

As further seen in FIG. 5, comer gaps 40 are formed between the adjacent ends 42 of adjoining moldings 18. In order to provide a pleasing look to the mirror frame 44 formed by the moldings 18, one or more comer pieces 46 (FIG. 6) may be used to cover the gaps 40. Preferably one comer piece 46 is fixed in place over each comer gap 40.

Comer piece 46 may be formed as a rigid plastic molding and may have any suitable shape which covers each respective gap 40. In FIG. 6, the comer piece 46 is formed with a body which is shaped as rectangular plate 47 having a pair of rearwardly extending flanges or rims 48.

As further seen in FIG. 6, one comer piece 46 has been permanently fixed over the upper right comer of mirror 10, and a second loose comer piece 46 has been placed in position over the upper left comer of mirror 10 and is ready to be fixed to frame 44. A bubble level 26 can be held on the top rim 48 of the comer piece 46 as it is aligned squarely with the comer ends 42 which define the gap 40 over which the corner piece is to be mounted. The level 26 and comer piece 46 can be held with the same hand during alignment and permanent mounting of the comer piece.

A particular advantage of comer piece 46 is the provision of a layer of adhesive 50 (FIGS. 8-11) on the interior surface 51 of plate 47 on each comer piece 46. The adhesive layer or adhesive member 50 can take the form of a layer of tacky adhesive cement, or preferably a pad of double-sided adhesive tape, such as foamed sponge tape having adhesive provided on both sides. The exterior surface 53 of the comer piece can be flat, contoured or patterned, if desired.

As seen in dashed lines in FIG. 8, the adhesive member 50 is in the form of a rectangular or square pad of double-sided adhesive tape. Of course, the adhesive member 50 may be provided in virtually any shape, as long as it has sufficient surface area to securely hold the comer piece 46 in place on frame 44.

As further seen in FIGS. 6-11, each comer piece 46 includes a removable, peelable covering 52 which overlies, covers and protects the adhesive member 50 until the corner piece is adjusted into proper position for permanent mounting to a comer of mirror 10. Covering 52 can be a thin flexible sheet of non-stick plastic material which can be easily peeled from the adhesive member 50.

Although covering 52 can be provided as a single unitary sheet, it is preferable to divide covering sheet 52 into two separate pull strips, 54, 56, as best seen in FIG. 8. In this example, covering 52 is formed as an L-shaped sheet, with each leg of the sheet forming a respective pull strip 54, 56.

An important feature of the covering 52 of FIGS. 6-11, is the formation of a weakened or cut portion 60 between the pull strips 54, 56. This weakened or cut portion 60 is preferably formed as a bias cut, extending diagonally from the exterior comer of the vertex 62 (FIG. 8) of the L-shaped covering 52 to the interior comer of vertex 64 of the L-shaped covering. The cut portion 60 also extends diagonally over the adhesive member 50.

The weakened or cut portion 60 may be formed as a perforated line, a partially cut score line or a totally severed through-cut. Of course, separate cover pieces or pull strips 54, 56 can be applied individually over the adhesive member 50, or separate pull strips 54, 56 can cover separate adhesive members 50 which are spaced apart on the interior surface 51 of the comer piece 46.

Referring again to FIG. 6, an assembler can hold the comer piece 46 and level 36 with one hand while pressing the comer piece against the molding end portions 42. Using the other hand, the assembler can grasp one of the pull strips 54, 56 which extend outwardly from beneath the comer piece, and then sequentially pull the pull strips away from the underlying adhesive member 50, as indicated by the directional arrows 66.

Once one of the pull strips 54, 56 is pulled away and removed from the adhesive member 50, a triangular-shaped patch of adhesive immediately attaches to and securely holds the comer piece 46 to the underlying moldings 18. The triangular-shaped patch of adhesive is formed of sufficient size to firmly hold the comer piece in fixed position so that the assembler need not any longer hold the comer piece in position while the second pull strip is removed. That is, the assembler can release the hand hold on the comer piece 46 after one of the pull strips 54, 56 is removed.

By arranging the pull strips 54, 56 at right angles to one another, they can be easily pulled away from the adhesive member 50 along the weakened or cut score line portion 60, which bisects the angle between the pull strips. Once both pull strips are removed, the entire adhesive member forms a secure adhesive bond between the comer piece 46 and the underlying moldings 18. Adhesive member 50 can be positioned so as to span gap 40 and bond to each adjoining comer end 42. This provides additional strength to frame 44.

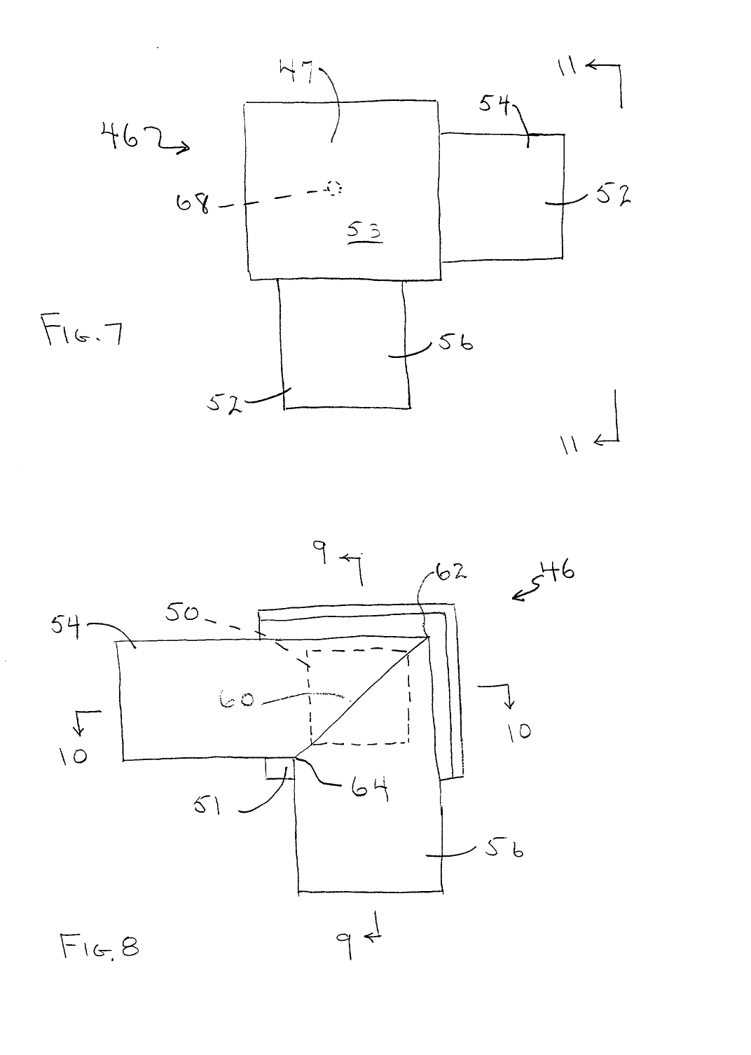

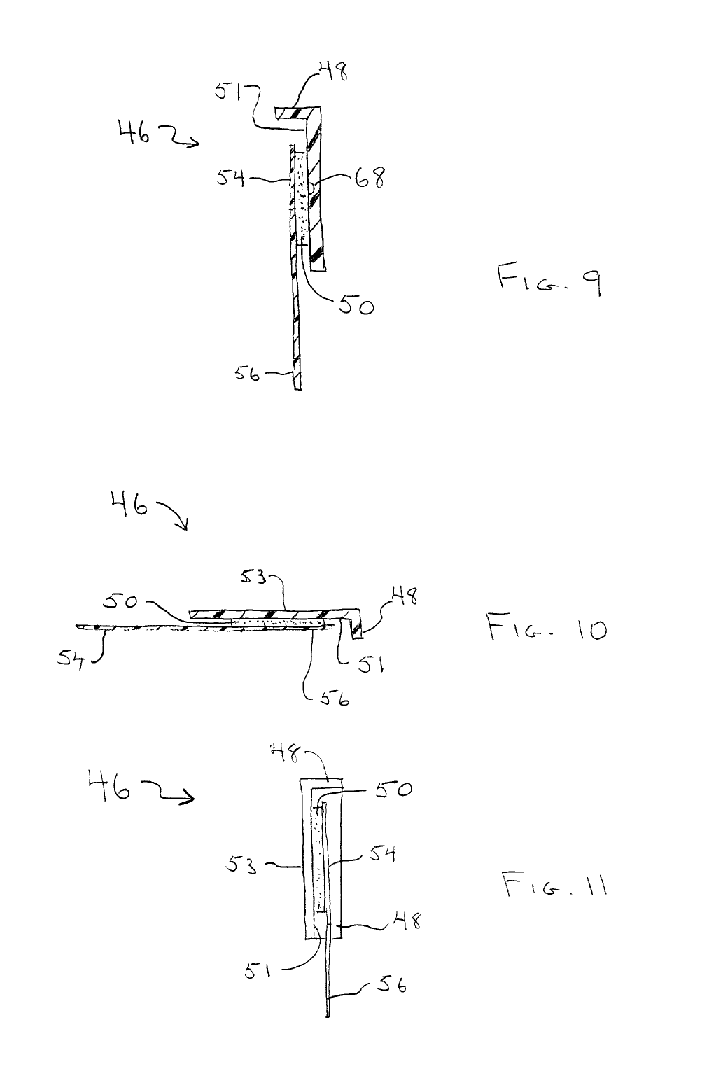

If desired, a hole or indentation 68 (FIGS. 7 and 9) can be formed on interior surface 51 of comer piece 46. Indentation 68 can be easily pierced to receive the fastening post of a decorative rosette, as is common in the art.

While the comer piece 46 is shown as a square planar cap having a pair of adjoining rims or flanges 48, it should be noted that corner piece 46 can be contoured to cover virtually any underlying molding configuration, such as the common conventional “J-channel” flat moldings widely available for framing mirrors.

There has been disclosed heretofore the best embodiment of the invention presently contemplated. However, it is to be understood that the various changes and modifications may be made thereto without departing from the spirit of the invention.

What is claimed is:

1. A method for framing a mirror with molding, comprising:
providing an adhesive member on said molding;
providing a removable cover on said adhesive member;
placing said molding against said mirror; and
removing said removable cover from said adhesive member while said molding is placed against said mirror.

2. The method of claim 1, which further comprises removing a portion of said removable cover from said adhesive member so as to form a free end portion prior to placing said molding against said mirror.

3. The method of claim 2, wherein said free end portion extends from beneath said molding, and said removable cover is removed by pulling on said free end portion.

4. The method of claim 1, further comprising placing a level on said molding as said molding is placed against said mirror.

5. The method of claim 4, wherein said level and said molding are held with one hand as said removable cover is removed with another hand.

6. A comer piece for covering a mirror molding, comprising:
a body having an interior surface and an exterior surface;
an adhesive member attached to said interior surface; and
a removable covering covering said adhesive member and projecting outwardly from said body.

7. The comer piece of claim 6, wherein said adhesive member comprises double-sided tape.

8. The comer piece of claim 6, wherein said removable covering comprises a sheet of plastic.

9. The comer piece of claim 6, wherein said removable covering comprises an L-shaped covering.

10. The corner piece of claim 6, wherein said removable covering comprises a first pull strip and a second pull strip.

11. The comer piece of claim 6, wherein said removable covering comprises a weakened portion separating said removable covering into a pair of removable coverings.

12. The comer piece of claim 11, wherein said removable covering comprises an L-shaped covering having a pair of legs and wherein said weakened portion extends between said pair of legs so as to define said pair of removable coverings.

13. The comer piece of claim 6, wherein said adhesive member comprises a rectangular member, and wherein said removable covering comprises a first pull strip and a second pull strip.

14. The corner piece of claim 13, wherein said first and second pull strips meet along a weakened or cut portion of said covering extending diagonally across said adhesive member.

15. A method of attaching a comer piece over a molding forming a frame around a mirror, wherein said method comprises:
providing an adhesive member on said comer piece;
providing a removable cover on said adhesive member;
placing said comer piece against said molding; and
removing said removable cover from said adhesive member while said comer piece is placed against said molding.

16. The method of claim 15, wherein said removable cover comprises a first pull strip and a second pull strip and wherein said removing comprises removing said first pull strip and then removing said second pull strip.

17. The method of claim 16, wherein said first and second pull strips extend from beneath said comer piece, and wherein said first pull strip is pulled in a direction away from said second pull strip.

18. The method of claim 16 wherein said first and second pull strips adjoin along a weakened or cut section in said covering and wherein said first pull strip is separated from said second pull strip along said weakened or cut section.

19. The method of claim 15, which further comprises holding a level on said comer piece as said removable cover is removed.

20. The method of claim 15, wherein said frame comprises a plurality of moldings defining at least one gap therebetween, and wherein said method further comprises placing said comer piece and said adhesive member over said gap.
